(19) United States
(12) Patent Application Publication
(10) Pub. No.: US 2006/0250587 A1
(43) Pub. Date: Nov. 9, 2006

(54) Image projection method and projection system

(76) Inventors: Regis Grasser, Mountain View, CA (US); Andrew Huibers, Palo Alto, CA (US); Michel Combes, Palo Alto, CA (US)

Correspondence Address: TEXAS INSTRUMENTS INCORPORATED, P O BOX 655474, M/S 3999, DALLAS, TX, 75265, US

(21) Appl. No.: 11/300,184

(22) Filed: Dec. 14, 2005

Related U.S. Application Data
(60) Provisional application No. 60/678,617, filed on May 5, 2005.

(51) Int. Cl. G03B 21/28

(52) U.S. Cl. 353/99

(57) ABSTRACT

Disclosed herein is a method of projecting images using reflective light valves. Pixel patterns generated of the light valve pixels based on image data are projected at different locations at a time.

### CROSS-REFERENCE TO RELATED CASES

The subject matter of U.S. provisional patent application Ser. No. 60/678,617 filed May 5, 2005; and Ser. No. 11/169,990 filed Jun. 28, 2005 are incorporated herein by reference in entirety.

### TECHNICAL FIELD OF THE INVENTION

The present invention is generally related to the art of image projection, and more particularly, to method of projecting images with reflective light valves having individually addressable pixels.

### BACKGROUND OF THE INVENTION

Projection systems using reflective light valves generate images by modulating incident light beams with individually addressable pixels of the reflective light valves based on desired images; and projecting the modulated light onto screens for viewing. Due to the limited physical sizes of the pixels, gaps between the adjacent pixels, and number of pixels in each light valve, the projection systems may suffer from artificial effects, one of which is the screen-door effect.

The screen-door effect or fixed pattern noise is a visual artifact wherein the fine lines separating the physical pixels of the light valves become noticeable in the projected images. The projected images appear as if viewed through a screen door. It may also appear as a grid structure or the like, such as hexagonal structure.

Therefore, what is needed is a method of projecting images using reflective light valves with minimized artificial effects, including the screen-door effect.

### SUMMARY OF THE INVENTION

In view of foregoing, an image projection method using a reflective light valve is disclosed herein. Artificial effects including the screen-door effect can be minimized by projecting the same or different frames of image data at different locations of the screen. The distances between such different locations are associated with the direction of the relative displacements between the different locations.

In one example, a method is disclosed. The method comprises: directing light onto a spatial light modulator comprising an array of device pixels resulting in modulated light; projecting the modulated light to a first array of image pixels on a screen with a pitch that is defined as a center-to-center distance between the adjacent image pixels; projecting the modulated light to a second image pixel array on the screen; and wherein the image pixels of the first and second image pixel arrays on which the modulated light are projected from the same device pixel have an offset less than \sqrt{2}/2 of the pitch on the screen.

In another example, a method is disclosed, which comprises: directing light from a light source onto a spatial light modulator comprising a plurality of spatial light modulator pixels including a first spatial light modulator pixel; providing a first image on a target from light reflected from the spatial light modulator, wherein the first spatial light modulator pixel forms a corresponding first image pixel on the target; and wherein a center of the first image pixel is disposed at a first distance from a center of an adjacent pixel image; providing a second image on the target from light reflected from the spatial light modulator, wherein the first spatial light modulator pixel forms a second image pixel on the target at a position offset from the position of the first image pixel; and wherein a difference in position between the first image pixel and the second image pixel is less than \sqrt{2}/2 of the first distance.

In yet another example, a projector is provided, which comprises: first means for directing light onto a spatial light modulator comprising an array of device pixels resulting in modulated light; second means for projecting the modulated light to a first array of image pixels on a screen with a pitch that is defined as a center-to-center distance between the adjacent image pixels; third means for projecting the modulated light to a second image pixel array on the screen; and wherein the image pixels of the first and second image pixel arrays on which the modulated light are projected from the same device pixel have an offset less than \sqrt{2}/2 of the pitch on the screen.

In yet another example, a method is disclosed, comprising: receiving a sequence of image frames; directing light onto a spatial light modulator comprising an array of device pixels resulting in a first modulated light according to a first image frame of the sequence of frames; projecting the first modulated light according to the first image frame to a first array of image pixels on a screen with a pitch that is defined as a center-to-center distance between the adjacent image pixels; modulating the light by the spatial light modulator according to a second image frame resulting in a second modulated light; projecting the second modulated light to a second image pixel array on the screen; and wherein the image pixels of the first and second image pixel arrays on which the modulated light are projected from the same device pixel have an offset less than \sqrt{2}/2 of the pitch on the screen.

In still yet another example, a method is disclosed, comprising: directing light from a light source onto a spatial light modulator; providing a first image on a target from light reflected from the spatial light modulator, wherein the first image is an image formed of a first array of first image pixels on the target, the first image pixels having a pitch defined as a center to center distance between adjacent image pixels; providing a second image on the target from light reflected from the spatial light modulator, wherein the second image is an image formed of a second array of image pixels spatially offset from the first array of images on the target; and wherein a difference in position between the first image pixels and the second image pixels is less than ⅓ the pitch.

Objects and advantages of the present invention will be obvious, and in part appear hereafter and are accomplished by the present invention. Such objects of the invention are achieved in the features of the independent claims attached hereto. Preferred embodiments are characterized in the dependent claims.

### BRIEF DESCRIPTION OF THE DRAWINGS

The accompanying drawings are illustrative and are not to scale. In addition, some elements are omitted from the drawings to more clearly illustrate the embodiments. While the appended claims set forth the features of the present invention with particularity, the invention, together with its objects and advantages, may be best understood from the following detailed description taken in conjunction with the accompanying drawings, in which:

FIG. 1 demonstratively illustrates an exemplary image projection method with an exemplary pixel array;

FIG. 2 demonstratively illustrates an exemplary image projection method with another exemplary pixel array;

FIG. 3 illustrates a block diagram showing the functional modules of a projection system in connection with the image projection system of the invention;

FIG. 4 is an exemplary light guiding module in FIG. 2;

FIG. 5 is another exemplary light guiding module in FIG. 2;

FIG. 6 is yet another exemplary light guiding module in FIG. 2;

FIG. 7 is an exemplary projection system in which embodiments of the invention can be implemented therein;

FIG. 8 is an exemplary illumination system used in FIG. 7;

FIG. 9 is another exemplary projection system in which embodiments of the invention can be implemented therein;

FIG. 10 is another exemplary illumination system usable in the projection system in FIG. 9;

FIG. 11 is yet another exemplary projection system in which embodiments of the invention can be implemented therein;

FIG. 12 is a cross-section view of an exemplary micromirror device usable in the reflective light valves as shown in FIG. 3, FIG. 7, FIG. 9, and FIG. 11;

FIG. 13 is a perspective view of an exemplary micromirror of FIG. 12;

FIG. 14 is a perspective view of an exemplary micromirror array device usable in the reflective light valves in FIG. 3, FIG. 7, FIG. 9, and FIG. 11;

FIG. 15 is a cross-sectional view of the micromirror array device in a package;

FIG. 16 is a top view of another exemplary micromirror array usable in the reflective light valves in FIG. 3, FIG. 7, FIG. 9, and FIG. 11;

FIG. 17 is a top view of yet another exemplary micromirror array usable in the reflective light valves in FIG. 3, FIG. 7, FIG. 9, and FIG. 11;

FIG. 18 is a top view of yet another exemplary micromirror array usable in the reflective light valves in FIG. 3, FIG. 7, FIG. 9, and FIG. 11; and

FIG. 19 is a block-diagram showing the functional modules of the projection system in which embodiments of the invention are implemented.

### DETAILED DESCRIPTION OF THE DRAWINGS

The present invention will be discussed in the following with reference to examples wherein the reflective valve comprises an array of deflectable reflective micromirrors. However, it will be understood that the following discussion is for demonstration purposes, and should not be interpreted as a limitation. Instead, any variations without departing from the spirit of the invention are applicable. For example, the invention is also applicable to other type of digital light valves, such as liquid-crystal cells, liquid-crystal on silicon cells, and other types of digital light valves.

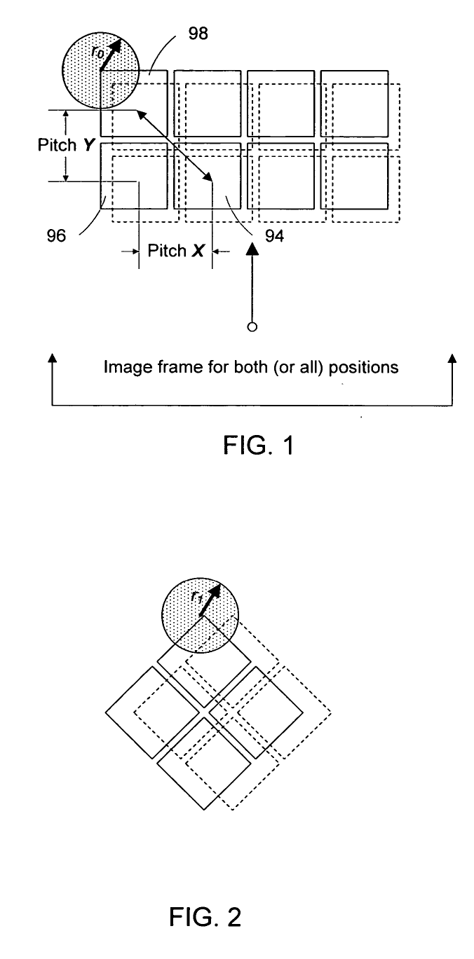

Turning to the drawings, FIG. 1 illustratively demonstrates an image projection method according to the invention. Media content frames, such as image frames and video frames are retrieved by the projection system, and each frame of the images (and/or videos), in entirety (e.g. without further derivation), is projected at different locations on the screen.

Specifically, the desired media content can be (through not required) retrieved in frames by the projector. The frame rate can be around 45 HZ or more, 60 HZ or more, and 120 HZ or more. A frame of image date (e.g. bitplane data) commensurate with the projector is then derived from each image frame. The derived frame of image data is delivered to the pixels of the reflective light valve of the projector. Based on the image data, the pixels modulate the incident light. The modulated light is then projected at the different locations on the screen so as to reproduce the desired media content.

The different locations can be of any desired numbers, such as 2 or more, 3 or more, and 4 or more. The different locations at which the same image frame are projected on the screen can be arranged horizontally (e.g. parallel to the rows of the image pixels), vertically (e.g. parallel to the columns of the image pixel array), or along other desired directions, such as along the diagonal of image pixels, as shown in FIG. 1.

As shown in FIG. 1, solid squares represent the image pixels at the first location; while the dash-line squares represent the image pixels at the second location. The two locations can be offset along the diagonal of the image pixels with the offset distance within the shaded circle. The shaded circle may have a radius r₀ equal to or less than half of the pitch along the offset direction, wherein the pitch is defined as the center-to-center distance between the adjacent image pixels along the offset direction. In this particular example as shown in FIG. 1, the offset id along the diagonal of the image pixels, the pitch is the center-to-center distance between image pixels 98 and 94. r₀ can then be expressed as:

$${r}_{o} \leq \frac{\sqrt{2}}{2} \times {P}_{xy}$$

wherein P_{xy} is the center-to-center distance between image pixels 98 and 94. More preferably, r₀ can be P_{xy}/2 or less, \sqrt{2} P_{xy}/3 or less, and \sqrt{2} P_{xy}/4 or less. Alternatively, r₀ can be greater than gap (the shortest distance) between adjacent image pixels (e.g. image pixels 98 and 94) along the offset direction, but smaller than ⅓ of the pitch along the offset direction, more preferably, greater than 1.5 times of the gap but less than 3 times of the gap along the offset direction.

In another example, the shaded circle may have a radius r₀ equal to or less than the half of the diagonal of the image pixel, which can be expressed as:

$${r}_{o} \leq \frac{\sqrt{{a}^{2} + b}}{2} \qquad Equation 1$$

wherein a and b are the sides of the image pixel. When the image pixels are square where a=b, equation 1 is reduced to:

$${r}_{o} \leq \frac{\sqrt{2}}{2} a \qquad Equation 2$$

As a way of example wherein the pixels are squares and the frame image is projected at two locations, the two different locations can be offset by \sqrt{2} a/2 or less, \sqrt{2} a/3 or less, and \sqrt{2} a/4 or less.

Instead of offsetting along the diagonal of the image pixels, the different locations can be offset along any other directions, such as horizontally (e.g. parallel to the rows of the pixel array) or vertically (e.g. along the columns of pixel array) or any combinations thereof. In the instance wherein the different locations are offset along the rows (or columns) of the image pixel array, the offset distance is preferably equal to and less than the half of the pitch size along the offset direction. Specifically, the offset can be expressed as:

$$offset < \{ \begin{matrix}\frac{{P}_{x}}{2} , & along the rows \\ \frac{{P}_{y}}{2} , & along the columns\end{matrix} \qquad Equation 3$$

wherein Pₓ is the pitch along the row (e.g. the center-to-center distance between image pixels 96 and 94; and P_{y} is the pitch along the column (e.g. the center-to-center distance between image pixels 98 and 98). Alternatively, the offset can be can be greater than gap (the shortest distance) between adjacent image pixels along the offset direction, but smaller than ⅓ of the pitch along the offset direction, more preferably, greater than 1.5 times of the gap but less than 3 times of the gap along the offset direction. For example wherein the offset is along the row, the offset can be greater than gap between adjacent image pixels 96 and 94, but smaller than ⅓ of pitch Pₓ, more preferably, greater than 1.5 times of the gap but less than 3 times of the gap along the offset direction. In the example wherein the offset is along the column, the offset can be greater than gap between adjacent image pixels 98 and 96, but smaller than ⅓ of pitch P_{y}, more preferably, greater than 1.5 times of the gap but less than 3 times of the gap along the offset direction. Another example wherein the offset is along the rows of the image pixel array is schematically illustrated in FIG. 2.

Referring to FIG. 2, each image pixel of the image pixel array is rotated an angle, such as 450 degrees along the center of each individual image pixel, as compared to that show in FIG. 1. This configuration results in that each edge of every image pixel has an edge to any edges of the image pixel array, as set forth in U.S. Pat. No. 6,962,419 issued Nov. 8, 2005, the subject matter being incorporated herein by reference in entirety.

In an image projection, the same frame of images is projected at different locations on the screen. As shown in the figure, the solid squares represent the image pixels ate the first location; while the dash-line squares represent the image pixels at the second location. The fist and second locations have an offset along the rows of the image pixel array. The offset is preferably less than a/2 according to equation 3. Alternatively, the offset can be along the columns, which is not shown in the drawing, wherein the offset is preferably less than b/2 according to equation 3. In other examples, the offset can be along any desired directions with the offset satisfying equations 1 to 3.

Instead of two locations as illustrated in FIG. 1 and FIG. 2, the same frame image can alternatively be projected at more than two different locations, such as 3 or more and 4 or more. Moreover, different frames of images can be projected as the above discussed locations. As a way of example, a video generally carries a sequence of frames of images. In the example as discussed above, the same frame image of the sequence of images can be projected as the different locations on the screen as discussed above. Alternatively, the different frames of the sequence of frames can be projected at the above discussed different locations. In yet another example, each image frame can be divided into sub-frames; and the sub-frames can be projected at the above discussed different locations, though not necessarily. Regardless of the number of different positions and relative arrangements, the different positions can be discrete, as compared to continuous—that is there is no intermediate positions or states located therebetween.

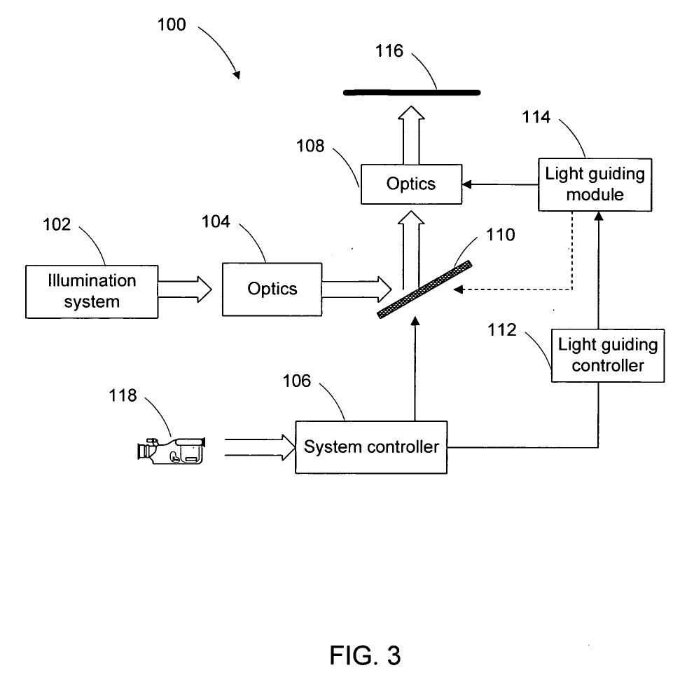

The image projection method of the invention can be implemented in many types of projection systems, an example of which is illustrated in a block-diagram in FIG. 3. Referring to FIG. 3, projection system 100 comprises illumination system 102 for providing illumination light for the system. The illumination light is collected and focused onto reflective light valve 110 through optics 104. Light valve 110 that comprises an array of individually addressable reflective elements, such as micromirror devices, modulates the illumination light under the control of system controller 106. The modulated light is collected and projected to screen 116 by optics 108. According to one example of the invention, each frame of the media contents is projected to the screen at different locations in entirety, which is controlled by system controller 106, as well as light guiding controller 112, and light guiding module 114.

As a way of example, the system controller receives a series of frames of media contents, such as images and videos, from media source 118. For achieving intermediate illumination intensities (e.g. the gray-scale) of the media contents, each frame of media contents is formatted into a set of bitplanes according a pulse-width-modulation technique. Each bitplane has one bit of data for each pixel of the image to be produced; and represents a bit-weight if intensity values to be displayed by the image pixel such that, each bitplane has a display time corresponding to its weight. During a frame period, the series of bitplanes derived from the same frame of media content (though not required) can be loaded to the pixels of the light valve; and used to control the ON and OFF states of the individual pixels of the light valve in modulating the incident light. The modulated light, however, is projected at different locations on the screen, which is accomplished through the light guiding module and light guiding controller. The light guiding module is capable of, statically or dynamically, projecting a single beam of modulated light at different locations on the screen under the control of the light guiding controller. Specifically, the entire series of bitplanes derived from each frame of media contents is displayed at different locations on the screen according to a method as discussed above with reference to FIG. 1 and FIG. 2. Because each series of bitplane has substantially the same image resolution as the media content frame from which the series of bitplanes are derived; and the entire series of bitplanes is displayed at each one of the different locations on the screen, the image produced at each one of the different locations has substantially the same resolution as the media content frame from which the series of bitplanes is derived. Moreover, because the series of the bitplanes is displayed on the screen though on different locations, the bitplanes at each one of the different locations have substantially the same illumination intensity (e.g. bit-depth) as that in the bitplanes immediately after the derivation from the media content frame.

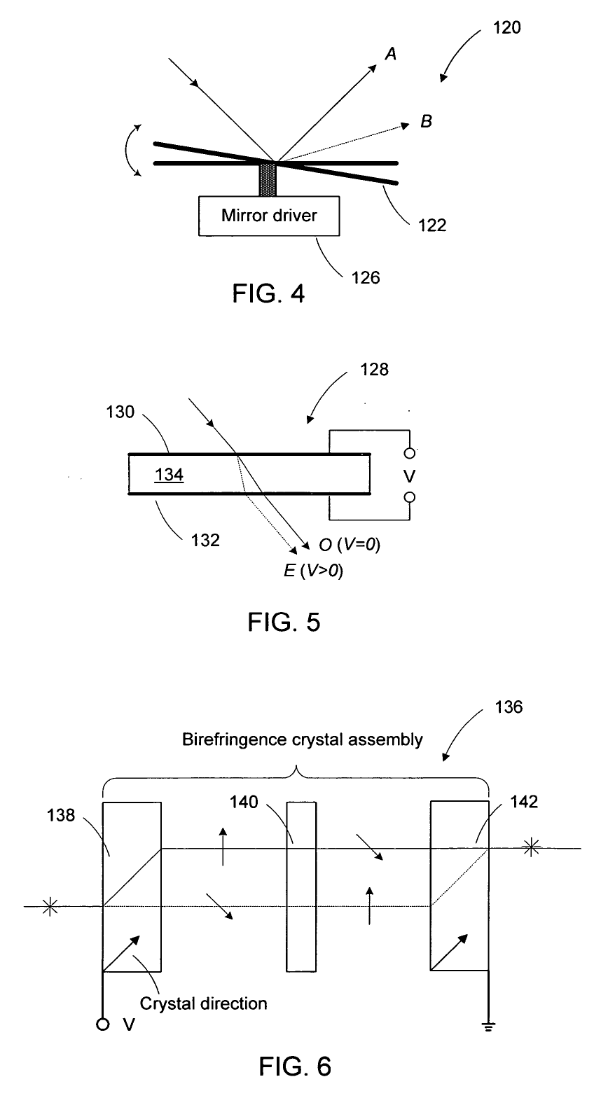

As discussed above, the series of bitplanes can be displayed at different locations on the screen statically or dynamically or in combination through the light guiding module. The light guiding module can be arranged to any suitable locations along the propagation path of the modulated light from the light valve. For example, the light guiding module can be disposed on the light valve thus to be a member thereof. The light guiding module can also be disposed between the light valve and other optics employed for directing the modulated light towards the screen. Alternatively, the light guiding module can be a member of the optics employed for directing the modulated light towards the screen. In another example, the light guiding module can be disposed between the optics employed for directing the modulated light towards the screen and screen, or any combinations of the above. Regardless of the differences in disposing the light guiding module, the light guiding module is arranged such that the modulated light from the light valve can be projected at the desired different locations on the screen, either statically or dynamically, examples of which will be detailed in the following with reference to FIG. 4 to FIG. 6.

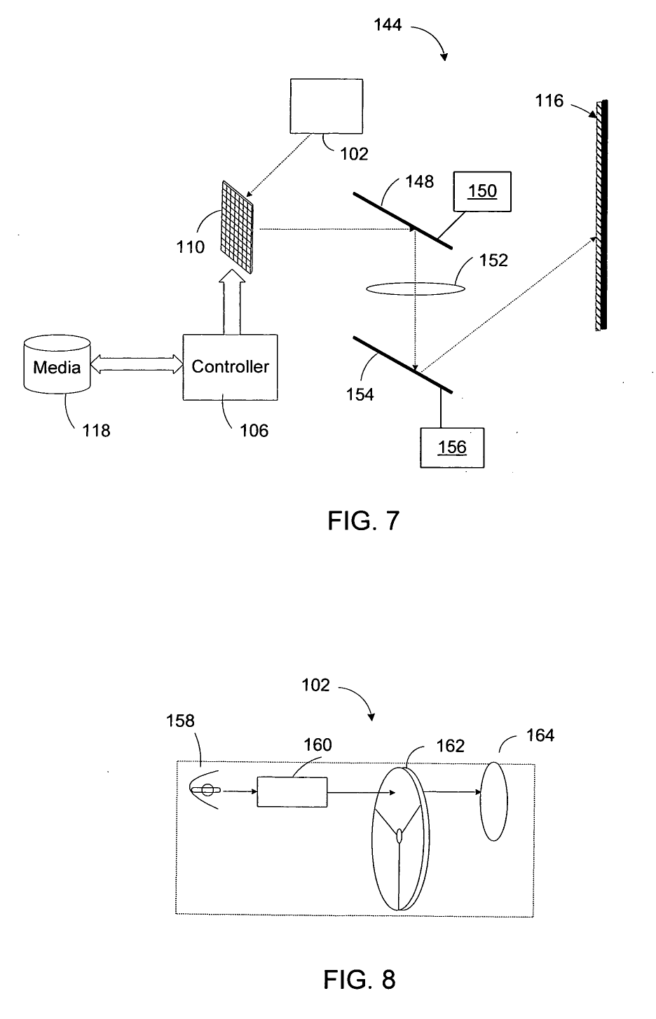

Referring to FIG. 4, an exemplary light guiding module capable of dynamically projecting the modulated light onto the screen is schematically illustrated therein. In this example, light guiding module 120 comprises folding mirror 122 connected to mirror driver 126 such that the folding mirror can vibrate in the vicinity of its natural resting position. Specifically, the light beam can be respectively reflected to direction A and direction B when the folding mirror is at different rotation positions. Vibration of the mirror plate can be accomplished through a mirror driver, such as a micro-actuator (e.g. a piezo-actuator). The frequency of vibrating the folding mirror is preferably equal to or higher than the flicker frequency of human eyes, such as 14 HZ or higher, 20 HZ or higher, 60 HZ or higher. In practice, multiple light guiding modules as that shown in FIG. 4 can be employed in a projection system, an example of which is illustrated in FIG. 7 and will be discussed afterwards.

FIG. 5 demonstratively illustrates another exemplary light guiding module that is capable of statically or dynamically projecting the modulated light from the light valve onto the desired different locations on the screen. Referring to FIG. 5, the light guiding modulate comprises a light transmissive plate 134 whose optical index n can be changed with external electrostatic fields. As shown in the figure, the optical index of the light transmissive plate can be changed by the DC or AC voltage signal applied across the light transmissive plate with electrodes 130 and 132 disposed on the opposite surfaces of the plate. At the first voltage, such as V=0, the plate exhibits the first optical index n₁. The light passing through the plate propagates along the first direction corresponding to one the desired different locations. At another voltage, such as a positive voltage V>O, the plate exhibits the second optical index n₂ different from n₁. The same light passing through the plate propagates along the second direction corresponding to another one of the desired different locations on the screen. Examples of the transmissive plate are birefringence crystals that includes hexagonal (e.g. calcite), tetragonal, and trigonal crystal classes. Exemplary birefringent crystal materials can be quartz, LiNbO₃, YVO₄ and other crystal materials. In fact, the light transmissive plate may have multiple optical indices. Examples of such materials can be birefringent crystals that include orthorhombic, monoclinic triclinic crystal classes. The crystals with multiple controllable optical indices are especially useful when the desired different locations on the screen are more then two. In fact, when the transmissive plate 134 is a birefringent or trirefringent crystal, external electrostatic field may not be necessary, because the crystal plate has intrinsic different optical indices.

In another example, birefringent crystals can be used assembled together for guiding the modulated light. An exemplary birefringent crystal is illustrated in FIG. 6. Referring to FIG. 6, birefringent crystal assembly 136 comprises birefringent crystals 138 and 142 with half-wave plate 140 disposed therebetween. Even illustrated in the figure where the plates are spaced, the plates are preferably laminated together as an assembly. With this assembly, omni-polarized light is split into ordinary and extraordinary beams that propagate along different directions. Specifically, the ordinary beam does alter its propagation path; while the extraordinary light propagates along a direction spaced apart from that of the ordinary beam. Separation of the two propagation paths is determined by the optical index and thickness of birefringent crystal 138.

Polarities of the ordinary and extraordinary beams are swapped after half-wave plate 140. Specifically, the ordinary beam before the half-wave plate is transformed to have a polarity of the extraordinary beam before the half-wave plate, and vise versa. Therefore, the ordinary beam immediately after birefringent crystal 138 is merged to the extraordinary beam split by birefringent crystal plate 138 after birefringent crystal plate 142, as shown in the figure. The propagation direction of the output light beam after the crystal assembly is spaced apart from the propagation path of the incident light beam. The offset distance between the incident light and output light is determined by the optical index of the birefringent crystals 138 and 142 and half-wave plate 140, the thicknesses of the crystal plates, as well as the crystal direction of the birefringent crystals 138 and 142 and half-wave plate 140.

The propagation path of the output light can be aligned to one of the desired different locations on the screen. For guiding the output light along the second direction towards another one of the desired different locations on the screen, an external electrostatic field can be established across either one or both of the birefringent crystals. In the example as shown in the figure, electrodes are attached to the surfaces of birefringent crystals 138 and 142. An external voltage DC or AC course is connected to the electrodes so as to establish an electric field across the entire assembly. With different voltages across the assembly, the propagation path of the output light can be altered; and the offset between the propagation paths of the output light at different voltages can be adjusted accordingly.

As one example, birefringent crystals 138 and 142 each can be a LiNbO₃ crystal or YVO₄ crystal with a thickness of 500 microns or larger, such as 1 mm or larger. The half-wave plate 140 can be quartz with a thickness preferably 20 microns or larger, such as from 50 to 100 microns, or even thicker than 1000 microns.

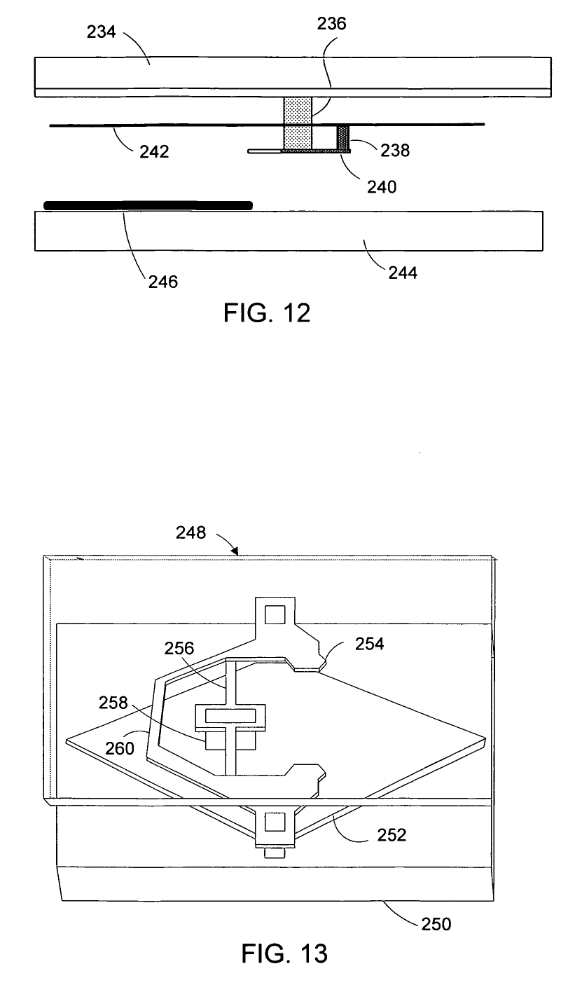

The projection system as discussed above with reference to FIG. 3 can be implemented in many ways, one of which is demonstratively illustrated in FIG. 7. Referring to FIG. 7, display system 144 comprises illumination system 102 providing light beams to illuminate light valve 110. Light valve 110 comprises an array of reflective deflectable pixels, such as liquid crystal on silicon cells and micromirror devices. The micromirrors can be the micromirrors having flat mirror plates (as to be shown in FIG. 12). The pixels of the light valve modulate the incident light beams according to image data (such as bitplane data) that are derived from the desired images and video signals. The modulated light beams are then reflected by folding mirror 148 that reflects the modulated light beams to another folding mirror 154 through projection lens 152. The light beams reflected from folding mirror 154 are then projected to display screen 116 so as to generate a pixel pattern.

An exemplary illumination system 102 is illustrated in FIG. 8. Referring to FIG. 8, the illumination system comprises light source 158, light pipe 160, color wheel 162, and condensing lens 164. The light source can be an arc lamp with an elliptical reflector. The arc lamp may also be the arc lamps with retro-reflectors, such as Philips BAMI arc lamps. Alternatively, the arc lamp can be arc lamps using Wavien reflector systems each having a double parabola. The light source can also be a LED.

The color wheel comprises a set of color segments, such as red, green, and yellow, or cyan, yellow and magenta. A white or clear or other color segments can also be provided for the color wheel. In the operation, the color wheel spins such that the color segments sequentially pass through the illumination light from the light source and generates sequential colors to be illuminated on the light valve. For example, the color wheel can be rotated at a speed of at least 4 times the frame rate of the image data sent to the reflective light valves. The color wheel can also be rotated at a speed of 240 Hz or more, such as 300 Hz or more.

The lightpipe is provided for delivering the light from the light source to the color wheel and, also for adjusting the angular distributions of the illumination light from the light source as appropriate. As an alternative feature, an array of fly's eye lenses can be provided to alter the cross section of the light from the light source.

Condensing lens 164 may have a different f-number than the f-number of projection lens 152 in FIG. 7. In this particular example, the color wheel is positioned after the light pipe along the propagation path of the light beams. In another embodiment, the color wheel can be positioned between the lightpipe and light source, which is not shown in the figure.

According to the embodiment of the invention, folding mirrors 148 or mirror 154 or both are movable. For example, folding mirror 148 can be rotated in the plane of the paper along a rotation axis that points out from the paper. Such rotation can be driven accomplished by a micro-actuator 150 (e.g. a piezo-actuator) connected to folding mirror 148. Similarly, folding mirror 154, if necessary, can be connected to micro-actuator 156 for rotating folding mirror 154. By rotating folding mirror 148 or folding mirror 154 or both, the modulated light from the light valve can be projected at the desired different locations on the screen.

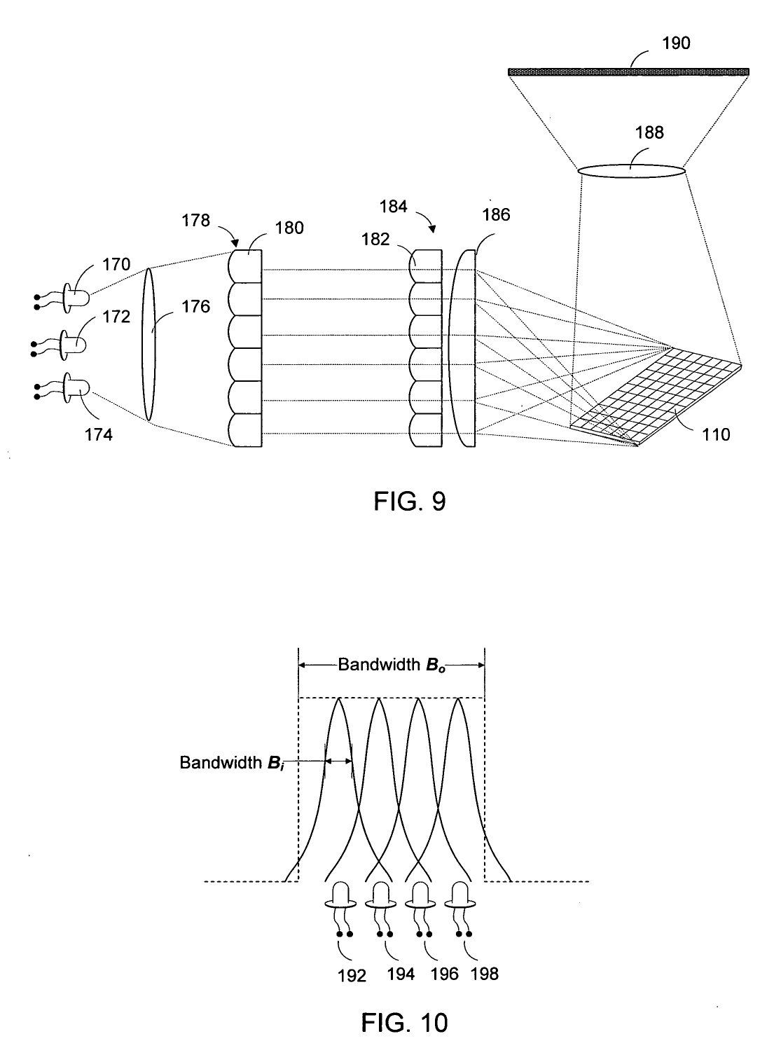

Referring to FIG. 9, an exemplary display system using LEDs as light source is demonstratively illustrated therein. In this example, the projection system comprises a LED array (e.g. LEDs 170, 172, and 174) for providing illumination light beam for the system. For demonstration purposes only, three LEDs are illustrated in the figure. In practice, the LED group may have any suitable number of LEDs, including a single LED. The LEDs can be of the same color (e.g. white color) or different colors (e.g. red, green, and blue). The light beams from the LED array are projected onto front fly-eye lens 178 through collimation lens 176. Fly-eye lens 178 comprises multiple unit lenses such as unit lens 180. The unit lenses on fly-eye lens 178 can be cubical lens or any other suitable lenses, and the total number of the unit lenses in the fly-eye lens 178 can be any desired numbers. At fly-eye lens 178, the light beam from each of the LEDs 170, 172, and 174 is split into a number of sub-light beams with the total number being equal to the total number of unit lenses of fly-eye lens 178. After collimate lens 176 and fly-eye lens 178, each LEDs 170, 172, and 174 is imaged onto each unit lens (e.g. unit lens 182) of rear fly-eye lens 184. Rear fly-eye lens 184 comprises a plurality of unit lenses each of which corresponds to one of the unit lenses of the front fly-eye lens 178, such that each of the LEDs forms an image at each unit lens of the rear fly-eye lens 182. Projection lens 186 projects the light beams from each unit lens of fly-eye lens 182 onto reflective light valves 110.

With the above optical configuration, the light beams from the LEDs (e.g. LEDs 170, 172, and 174) can be uniformly projected onto the micromirror devices of the reflective light valves.

In the display system, a single LED can be used, in which instance, the LED preferably provides white color. Alternatively, an array of LEDs capable of emitting the same (e.g. white) or different colors (e.g. red, green, and blue) can be employed. Especially when multiple LEDs are employed for producing different colors, each color can be produced by one or more LEDs. In practical operation, it may be desired that different colors have approximately the same or specific characteristic spectrum widths. It may also be desired that different colors have the same illumination intensity. These requirements can be satisfied by juxtaposing certain number of LEDs with slightly different spectrums, as demonstratively shown in FIG. 10.

Referring to FIG. 10, it is assumed that the desired spectrum bandwidth of a specific color (e.g. red) is B₀ (e.g. a value from 10 nm to 80 nm, or from 60 nm to 70 nm), and the characteristic spectrum bandwidth of each LED (e.g. LEDs 192, 194, 196, and 198) is Bᵢ (e.g. a value from 10 nm to 35 nm). By properly selecting the number of LEDs with suitable spectrum differences, the desired spectrum can be obtained. As a way of example, assuming that the red color with the wavelength of 660 nm and spectrum bandwidth of 60 nm is desired, the LEDs can be selected and juxtaposed as shown in the figure. The LEDs may have characteristic spectrum of 660 nm, 665 nm, 670 nm, and 675 nm, and the characteristic spectrum width of each LED is approximately 10 nm. As a result, the effective spectrum width of the juxtaposed LEDs can approximately be the desired red color with the desired spectrum width.

Different LEDs emitting different colors may exhibit different intensities, in which instance, the color balance is desired so as to generate different colors of the same intensity. An approach is to adjust the ratio of the total number of LEDs for the different colors to be balanced according to the ratio of the intensities of the different colors, such that the effective output intensities of different colors are approximately the same.

In the display system wherein LEDs are provided for illuminating a single reflective light valves with different colors, the different colors can be sequentially directed to the reflective light valves. For this purpose, the LEDs for different colors can be sequentially turned on, and the LEDs for the same color are turned on concurrently. In another system, multiple reflective light valvess can be used as set froth in US patent application “Multiple Reflective light valvess in a Package” to Huibers, attorney docket number P266-pro, filed Aug. 30, 2005, the subject matter being incorporated herein by reference in entirety. A group of LEDs can be employed in such a display system for producing different colors that sequentially or concurrently illuminate the multiple reflective light valvess.

For guiding the modulated light from light valve 110 to the desired different locations on the screen, the light guiding module (as that discussed with reference to FIG. 1 to FIG. 6) can be disposed at any suitable locations between the light valve and screen. In another example, light guiding module can be disposed on the light valve, as that shown in FIG. 15, which will be discussed afterwards.

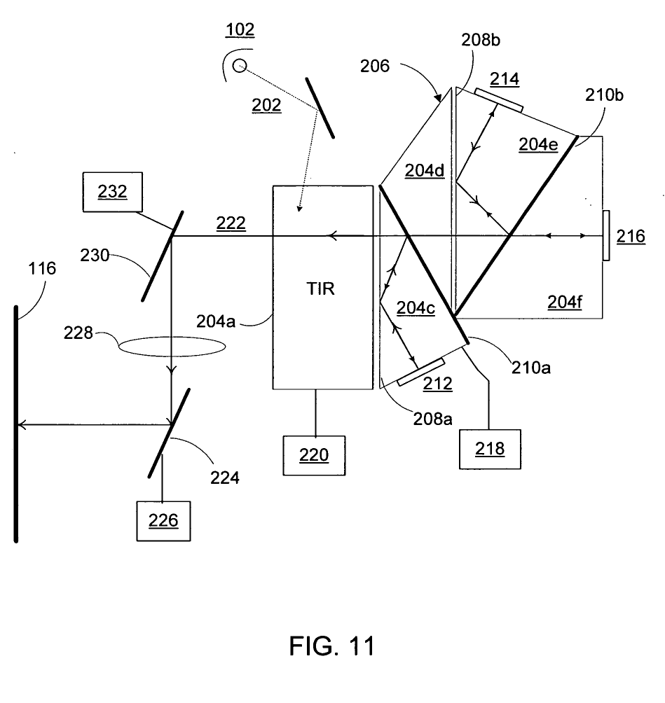

The projection method of the present invention can be implemented in display systems each having one reflective light valve. Alternatively, the embodiments of the present invention can be implemented in display systems having multiple reflective light valves, such as that in FIG. 11.

Referring to FIG. 11, the display system comprise uses a dichroic prism assembly 206 for splitting incident light into three primary color light beams. Dichroic prism assembly comprises TIR 204a, 204c, 204d, 204e and 204f. Totally-internally-reflection (TIR) surfaces, i.e. TIR surfaces 208a and 208b, are defined at the prism surfaces that face air gaps. The surfaces 210a and 210b of prisms 204c and 204e are coated with dichroic films, yielding dichroic surfaces. In particular, dichroic surface 210a reflects green light and transmits other light. Dichroic surface 210b reflects red light and transmits other light. The three light valves, 212, 214 and 216 are arranged around the prism assembly.

In operation, incident white light 202 from light source 102 enters into TIR 204a and is directed towards reflective light valves 216, which is designated for modulating the blue light component of the incident white light. At the dichroic surface 210a, the green light component of the totally internally reflected light from TIR surface 208a is separated therefrom and reflected towards reflective light valves 212, which is designated for modulating green light. As seen, the separated green light may experience TIR by TIR surface 208b in order to illuminate reflective light valves 212 at a desired angle. This can be accomplished by arranging the incident angle of the separated green light onto TIR surface 208b larger than the critical TIR angle of TIR surface 208b. The rest of the light components, other than the green light, of the reflected light from the TIR surface 208a pass through dichroic surface 210a and are reflected at dichroic surface 210b. Because dichroic surface 210b is designated for reflecting red light component, the red light component of the incident light onto dichroic surface 210b is thus separated and reflected onto reflective light valves 214, which is designated for modulating red light. Finally, the blue component of the white incident light (white light 202) reaches reflective light valves 186 and is modulated thereby. By collaborating operations of the three reflective light valves, red, green, and blue lights can be properly modulated. The modulated red, green, and blue lights are recollected and delivered onto screen 116 through optic elements, such as projection lens 228, if necessary.

In order to project the modulated light at the desired different locations on the screen, the combined light 222 is further manipulated through folding mirrors 230 and 224, and projection lens 228, wherein one or both of the folding mirrors are rotatable along axes passing their centers and pointing out from the paper. The rotations of the folding mirrors can be respectively driven by micro-actuators 232 and 226 that are respectively connected to the folding mirrors respectively.

In the operation, the combined light 222 is reflected from folding mirror 230 towards folding mirror 224 through projection lens 228. The combined light after folding mirror 224 is reflected to screen 116 so as to generate the desired images and/ or videos. By rotating either one or both of the folding mirrors, the modulated light from the light valve can be projected at the desired different locations on the screen. Alternatively, the same purpose can be accomplished by moving the triangular prism having the TIR surface of 208a and to which light valve 212 is attached. Such movement can be accomplished through micro-actuator 218 attached to the triangular prism.

The reflective light valves in the projection systems as discussed above each may be composed of any suitable elements, such as LCD elements, LCOS elements, micromirror devices, and other suitable elements. As a way of example, FIG. 12 illustrates a cross-section of an exemplary micromirror device. Referring to FIG. 12, the micromirror device comprises reflective deflectable mirror plate 242 that is attached to deformable hinge 240 via hinge contact 238. The deformable hinge, such as a torsion hinge is held by a hinge support that is affixed to post 236 on light transmissive substrate 234. Addressing electrode 246 is disposed on semiconductor substrate 244, and is placed proximate to the mirror plate for electrostatically deflecting the mirror plate. Other alternative features can also be provided. For example, a stopper can be provided for limiting the rotation of the mirror plate when the mirror plate is at the desired angles, such as the ON state angle. The ON state angle is preferably 10° degrees or more, 12° degrees or more, or 14° degrees or more relative to substrate 234. For enhancing the transmission of the incident light through the light transmissive substrate 234, an anti-reflection film can be coated on the lower surface of substrate 234. Alternative the anti-reflection film, a light transmissive electrode can be formed on the lower surface of substrate 234 for electrostatically deflecting the mirror plate towards substrate 234. An example of such electrode can be a thin film of indium-tin-oxide. The light transmissive electrode can also be a multi-layered structure. For example, it may comprise an electrically conductive layer and electrically non-conductive layer with the electrically conductive layer being sandwiched between substrate 234 and the electrically non-conductive layer. This configuration prevents potential electrical short between the mirror plate and the electrode. The electrically non-conductive layer can be SiOₓ, TiOₓ, SiNx, and NbOₓ, as set forth in U.S. patent application Ser. No. 11/102,531 filed Apr. 8, 2005, the subject matter being incorporated herein by reference. In other embodiments of the invention, multiple addressing electrodes can be provided for the micromirror device, as set forth in U.S. patent application Ser. No. 10/437,776 filed May 13, 2003, and Ser. No. 10/947,005 filed Sep. 21, 2004, the subject matter of each being incorporated herein by reference in entirety. Other optical films, such as a light transmissive and electrically insulating layer can be utilized in combination with the light transmissive electrode on the lower surface of substrate 234 for preventing possible electrical short between the mirror plate and light transmissive electrode.

In the example shown in FIG. 12, the mirror plate is associated with one single addressing electrode on substrate 244. Alternatively, another addressing electrode can be formed on substrate 244, but on the opposite side of the deformable hinge.

The micromirror device as show in FIG. 12 is only one example of many applicable examples of the invention. For example, in the example as shown in the figure the mirror plate is attached to the deformable hinge such that the mirror plate rotates asymmetrically. That is the maximum rotation angle (e.g. the ON state angle) achievable by the mirror plate rotating in one direction (the direction towards the ON state) is larger than that (e.g. the OFF stat angle) in the opposite rotation direction (e.g. the direction towards the OFF state). This is accomplished by attaching the mirror plate to the deformable hinge at a location that is not at the center of the mirror plate such that the rotation axis of the mirror plate is offset from a diagonal of the mirror plate. However, the rotation axis may or may not be parallel to the diagonal. Of course, the mirror plate can be attached to the deformable hinge such that the mirror plate rotates symmetrically. That is the maximum angle achievable by rotating the mirror plate is substantially the same as that in the opposite rotation direction.

The mirror plate of the micromirror shown in FIG. 12 can be attached to the deformable hinge such that the mirror plate and deformable hinge are in the same plane. In an alternative embodiment of the invention, the deformable hinge can be located in a separate plane as the mirror plate when viewed from the top of the mirror plate at a non-deflected state, which will not be discussed in detail herein.

Referring to FIG. 13, a perspective view of an exemplary micromirror device in which embodiments of the invention are applicable is illustrated therein. Deflectable reflective mirror plate 252 with a substantially square shape is formed on light transmissive substrate 248, and is attached to deformable hinge 256 via hinge contact 258. The deformable hinge is held by hinge support 260, and the hinge support is affixed and held by posts on the light transmissive substrate. For electrostatically deflecting the mirror plate, an addressing electrode (not shown in the figure for simplicity purposes) is fabricated in the semiconductor substrate 250. For improving the electrical coupling of the deflectable mirror plate to the electrostatic field, an extending metallic plate can be formed on the mirror plate and contacted to the mirror plate.

The mirror plate is preferably attached to the deformable hinge asymmetrically such that the mirror plate can be rotated asymmetrically for achieving high contrast ratio. The deformable hinge is preferably formed beneath the deflectable mirror plate in the direction of the incident light so as to avoid unexpected light scattering by the deformable hinge. For reducing unexpected light scattering of the mirror plate edge, the illumination light is preferably incident onto the mirror plate along a corner of the mirror plate.

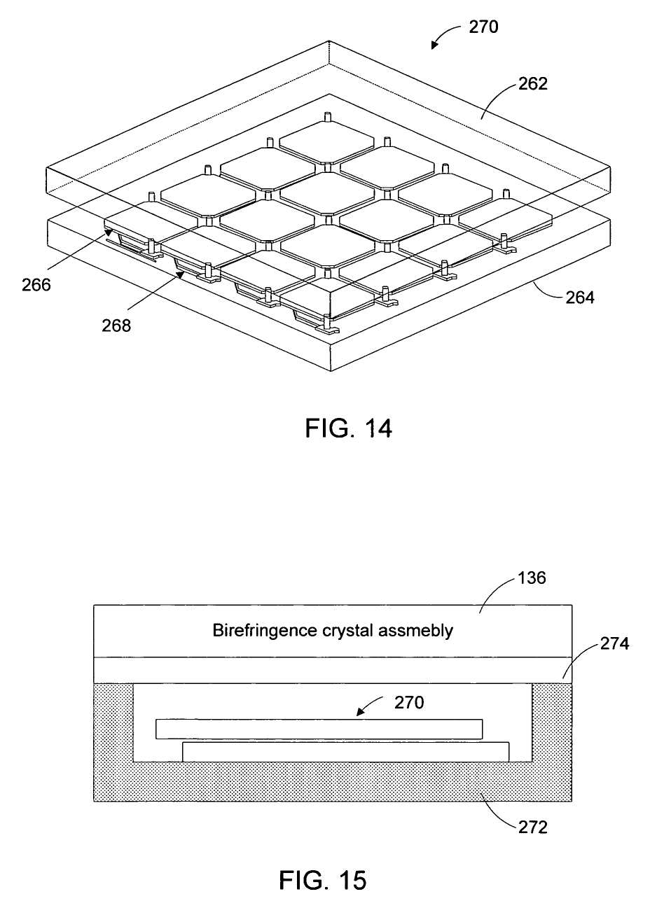

Referring to FIG. 14, an exemplary reflective light valves having an array of micromirrors of FIG. 13 is illustrated therein. For simplicity purposes, only 4×4 micromirrors are presented. In general, the micromirror array of a reflective light valves consists of thousands or millions of micromirrors, the total number of which determines the resolution of the displayed images. For example, the micromirror array of the reflective light valves may have 800×600 (SVGA) or higher, 1024×768 (XGA) or higher, 1280×1024 (SXGA) or higher, 1280×720 or higher, 1400×1050 or higher, 1600×1200 (UXGA) or higher, and 1920×1080 or higher, micromirror devices. In other applications, the micromirror array may have less number of micromirrors.

In this example, the array of deflectable reflective mirror plates 266 is disposed between light transmissive substrate 262 and semiconductor substrate 264 having formed thereon an array of addressing electrodes 268 each of which is associated with a mirror plate for electrostatically deflecting the mirror plate. The posts of the micromirrors can be covered by light blocking pads for reducing expected light scattering from the surfaces of the posts.

Often times, the light valves are enclosed within a package for protection. One exemplary package is shown in FIG. 15. Referring to FIG. 15, light valve 270, such as that shown in FIG. 14, is disposed on the supporting surface of a cavity of package substrate 272 that can be a ceramic or other suitable materials. Package lid 274, which can be a light transmissive plate, is hermetically or non-hermetically bonded to the package substrate so as to enclose light valve 270 within the space between the package lid and package substrate. As one example, optical guiding module 136, such as one of those discussed with reference to FIG. 5 and FIG. 6 can be disposed on the package lid, as shown in the figure. Alternatively, the light guiding module can be disposed within the space between the package lid and package substrate.

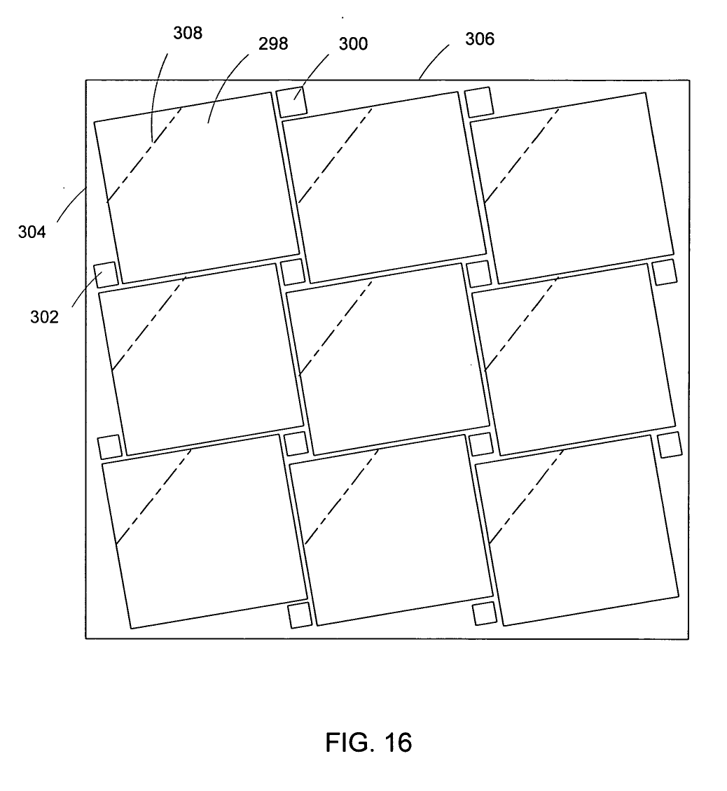

The micromirrors in the micromirror array of the reflective light valves can be arranged in alternative ways, another one of which is illustrated in FIG. 16. Referring to FIG. 16, each micromirror is rotated around its geometric center an angle less than 450 degrees. The posts (e.g. 300 and 302) of each micromirror (e.g. mirror 298) are then aligned to the opposite edges of the mirror plate. No edges of the mirror plate are parallel to an edge (e.g. edges 304 or 306) of the micromirror array. The rotation axis (e.g. axis 308) of each mirror plate is parallel to but offset from a diagonal of the mirror plate when viewed from the top of the mirror plate at a non-deflected state.

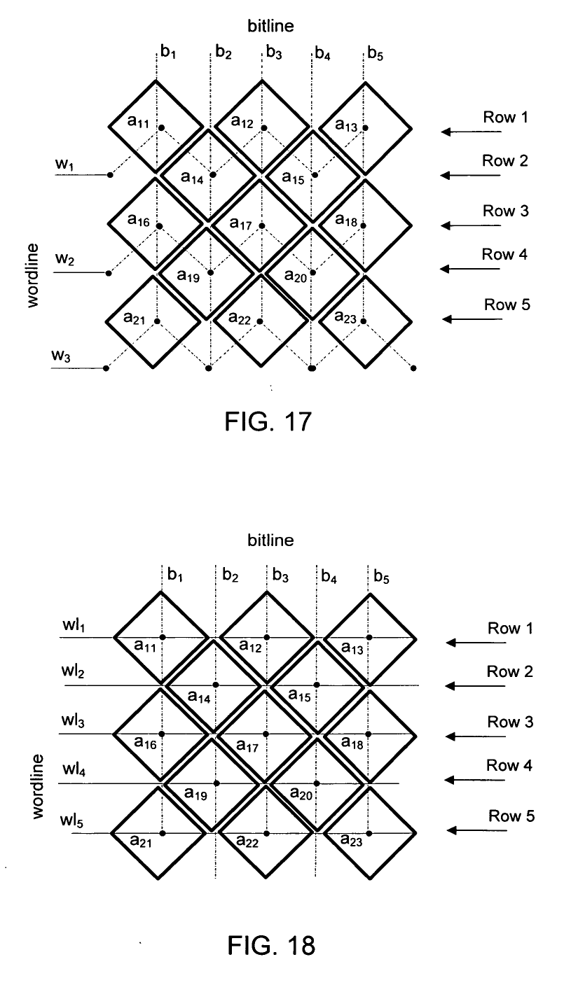

FIG. 17 illustrates the top view of another micromirror array having an array of micromirrors of FIG. 13. In this example, each micromirror is rotated 45° degrees around its geometric center. For addressing the micromirrors, the bitlines and wordlines are deployed in a way such that each column of the array is connected to a bitline but each wordline alternatively connects micromirrors of adjacent rows. For example, bitlines b₁, b₂, b₃, b₄, and b₅ respectively connect micromirrors groups of (a₁₁a₁₆, and a₂₁) (a₁₄ and a₁₉), (a₁₂, a₁₇, and a₂₂), (a₁₅ and a₂₀), and (a₁₃, a₁₈, and a₂₃). Wordlines w₁, w₂, and w₃ respectively connect micromirror groups (a₁₁, a₁₄, a₁₂, a₁₅, and a₁₃), (a₁₆, a₁₉, a₁₇, a₂₀, and a₁₈), and (a₂₁, a₂₂, and a₂₃). With this configuration, the total number of wordlines is less the total number of bitlines.

For the same micromirror array, the bitlines and wordlines can be deployed in other ways, such as that shown in FIG. 18. Referring to FIG. 18, each row of micromirrors is provided with one wordline and one bitline. Specifically, bitlines b₁, b₂, b₃, b₄ and b₅ respectively connect column 1 (comprising micromirrors a₁₁, a₁₆, and a₂₁), column 2 (comprising micromirrors a₁₄ and a₂₀), column 3 (comprising micromirrors a₁₂, a₁₇, and a₂₂), column 4 (comprising micromirrors a₁₅ and a₂₀), and column 5 (comprising micromirrors a₁₃, a₁₈, and a₂₃). Wordlines WL₁, WL₂, WL₃, WL₄, and WL₅ respectively connect row 1 (comprising micromirrors a₁₁, a₁₂, and a₁₃), row 2 (comprising micromirrors a₁₄ and a₁₅), row 3 (comprising micromirrors a₁₆, a₁₇, and a₁₈), row 4 (comprising micromirrors a₁₄ and a₂₀) and row 5 (comprising micromirrors a₂₁, a₂₂, and a₂₃).

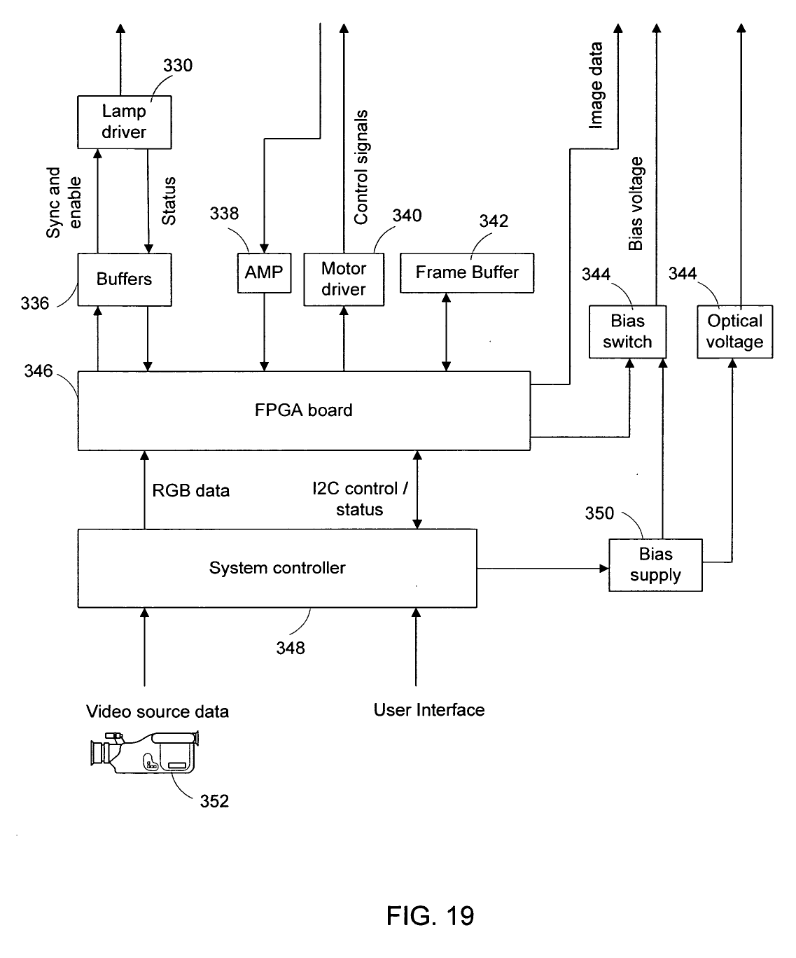

The image projection method as discussed above can be implemented in the system controller 106 as shown in FIG. 1. In particular, voltages used in controlling the electrostatic fields established across the birefringent plates, as those discussed with reference to FIG. 5 and FIG. 6, can be controlled by the system controller. As a way of example, FIG. 19 illustrates a block diagram showing the functional modules of the projection system. The system comprises system controller 348 for receiving image or video contents from source 352, and providing the user interface. The system controller can be a computing device having a CPU or microcontroller, which is responsible for all system supervisory functions. Such functions include, but not limited to, initialization and shutdown of the projector system, monitoring of the system's real-time status (temperature, lamp state), the product's user interface, and video source selection. The system controller will often reside in a scalar IC such as a PixelWorks or similar chip. The system controller is expected to interface with FPGA board 346 over the standard I2C interface. The system controller may act as the I2C master and the FPGA board may act as an I2C slave. The system controller can initiate write transactions to set various parameters within the FPGA chip, or initiating read transactions to verify parameters or check various status indications within the FPGA board.

The FPGA board receives instructions and image data from the system controller. With such instruction, the FPGA board is capable of controlling lamp 102, color wheel 106, and spatial light modulator 110. Specifically, the FPGA board sends instructions (e.g. synchronization and enable signals) and driving signals to lamp driver through buffer 336. The lamp driver drives the lamp with the received instructions and driving signals. Operations status of the lamp can be real-timely monitored by retrieving the status of the lamp through the buffer to the FPGA. For driving the color wheel, the FPGA board real-timely monitors the status (e.g. the phase of the color wheel) using photodetector 334. The output signal from the photodetector is delivered to amplifier 338 where the signal is amplified. The amplified status signal is obtained by the FPGA and analyzed accordingly. Based on the analyzed status of the color wheel, the FPGA board sends instructions and driving signals (e.g. driving current) to motor driver that controls the color wheel. An exemplary method of controlling the operations of the color wheel is set forth in U.S. patent application Ser. No. 11/128,607 filed May 13, 2005, the subject matter being incorporated herein by reference.

The FPGA board may be connected to build-in buffer 342 for saving and retrieving data, such as image data (e.g. bitplane data complying with certain format, as set forth in U.S. patent applications Ser. No. 11/120,457 filed May 2, 2005, Ser. No. 10/982,259 filed Nov. 5, 2004, Ser. No. 10/865,993 filed Jun. 11, 2004, Ser. No. 10/607,687 filed Jun. 17, 2003, Ser. No. 10/648,608 filed Aug. 25, 2003, and Ser. No. 10/648,689 filed Aug. 25, 2005, the subject matter of each being incorporated herein by reference.

For controlling the operations of the micromirror devices in spatial light modulator 110, the FPGA communicates with the spatial light modulator and sends prepared image data retrieved from buffer 342 and instruction signals to the spatial light modulator. As an alternative feature, the bias on the micromirror devices of the light valve can be adjusted, e.g. by changing the amplitude and/or polarity for eliminating potential charge accumulation and other purposes, as set forth in U.S. patent application Ser. No. 10/607,687 filed Jun. 17, 2003, Ser. No. 11/069,408 filed Feb. 28, 2005, and Ser. No. 11/069,317 filed Feb. 28, 2005, the subject matter of each being incorporated herein by reference.

The bias adjusting is accomplished through bias switch 344 and bias supply 350. The bias supply is connected to and controlled by system controller 348; while bias switch is controlled by the FPGA board. For controlling the light guiding module (e.g. 114 in FIG. 3), optical voltage module 344 is provided. The voltages used for establishing the electrostatic fields across the birefringent plates can be supplied by bias-voltage module 350, even not required. Of course, a separate voltage source can be provided.

It will be appreciated by those skilled in the art that a new and useful micromirror array device having light blocking pads have been described herein. In view of the many possible embodiments to which the principles of this invention may be applied, however, it should be recognized that the embodiments described herein with respect to the drawing figures are meant to be illustrative only and should not be taken as limiting the scope of invention. For example, those of skill in the art will recognize that the illustrated embodiments can be modified in arrangement and detail without departing from the spirit of the invention.

1. A method, comprising:
directing light onto a spatial light modulator comprising an array of device pixels resulting in modulated light;
projecting the modulated light to a first array of image pixels on a screen with a pitch that is defined as a center-to-center distance between the adjacent image pixels;
projecting the modulated light to a second image pixel array on the screen; and
wherein the image pixels of the first and second image pixel arrays on which the modulated light are projected from the same device pixel have an offset less than \sqrt{2}/2 of the pitch on the screen.

2. The method of claim 1, wherein the offset is less equal to or less than \sqrt{2}/3 of the pitch on the screen.

3. The method of claim 1, wherein the offset is less equal to or less than \sqrt{2}/4 of the pitch on the screen.

4. The method of claim 1, wherein the offset is less than \sqrt{2}/2 of a diagonal of the image pixel.

5. The method of claim 1, wherein the offset is less than \sqrt{2}/3 of a diagonal of the image pixel.

6. The method of claim 1, wherein the offset is along a diagonal of the image pixels.

7. The method of claim 1, wherein the offset is along a row or a column of the

8. The method of claim 5, wherein the offset is less than ½ of the width or column of an image pixel along a row or column of the image pixel array.

9. The method of claim 5, wherein the offset is less than ⅓ of the width or column of an image pixel along a row or column of the image pixel array.

10. The method of claim 5, wherein the offset is less than ¼ of the width or column of an image pixel along a row or column of the image pixel array.

11. The method of claim 9, wherein the offset is greater than a gap between adjacent image pixels, but less than ⅓ the pitch.

12. The method of claim 11, wherein the offset is greater than 1.5 times of the gap but less than 3 times the gap.

13. The method of claim 1, further comprising:
projecting the modulate light on a third array of image pixels on the screen other than the first and second arrays of image pixels.

14. The method of claim 13, further comprising:
projecting the modulate light on a forth array of image pixels on the screen other than the first, second, and third arrays of image pixels.

15. The method of claim 14, further comprising:
projecting the modulate light on a fifth array of image pixels on the screen other than the first, second, third, and forth arrays of image pixels.

16. The method of claim 1, wherein the light directed to the spatial light modulator is from an arc lamp.

17. The method of claim 1, wherein the light directed to the spatial light modulator is from a light source comprising a LED.

18. The method of claim 17, wherein the light source comprises an array of LEDs.

19. The method of claim 18, wherein the LEDs have different spectrums.

20. The method of claim 1, wherein the projecting of the modulated light onto the first and second arrays of image pixels are accomplished by a light module that is capable of directing the light onto different locations on the screen.

21. The method of claim 20, wherein the light module is disposed on the spatial light modulator.

22. The method of claim 21, wherein the light module comprises a birefringent crystal assembly attached to a package lid, said package lid is bonded to a package substrate resulting in a space in which the array of device pixels are enclosed.

23. The method of claim 22, wherein the birefringent crystal assembly comprises LiNbO₃.

24. The method of claim 23, wherein the birefringent crystal assembly comprises a half-wave crystal plate laminated between two LiNbO₃ crystals.

25. The method of claim 22, wherein the birefringent crystal assembly comprises YVO₄.

26. The method of claim 20, wherein the light module comprises a folding mirror disposed after the spatial light modulator along the propagation path of the modulated light.

27. The method of claim 26, wherein the folding mirror is disposed between the spatial light modulator and a projection lens for projecting the modulated light onto the screen.

28. The method of claim 20, wherein the light module is a vibrator connected to a projection lens for projecting the modulated light onto a screen such that the projection lens is capable of moving relative to the screen.

29. The method of claim 26, wherein the folding mirror is disposed after a projection lens for projecting the modulated light onto the screen.

30. The method of claim 20, wherein the light modulator comprises a vibrator that is connected to the spatial light modulator such that the spatial light modulator is capable of moving relative to the screen.

31. The method of claim 1, further comprising:
splitting the light into a set of different colors;
modulating the different colors separately by a spatial light modulator into different modulated colors; and
combining the different modulated colors into the modulated light.

32. The method of claim 31, wherein the different colors are modulated by different spatial light modulators.

33. The method of claim 31, wherein the different colors are modulated by at least two different spatial light modulators.

34. The method of claim 33, wherein the projecting of the modulated light onto the first and second arrays of image pixels are accomplished by a light module that is capable of directing the light onto different locations on the screen; and wherein the light module is disposed at a location when the different modulated colors are combined into the modulated light.

35. A method comprising:
directing light from a light source onto a spatial light modulator comprising a plurality of spatial light modulator pixels including a first spatial light modulator pixel;
providing a first image on a target from light reflected from the spatial light modulator, wherein the first spatial light modulator pixel forms a corresponding first image pixel on the target; and wherein a center of the first image pixel is disposed at a first distance from a center of an adjacent pixel image;
providing a second image on the target from light reflected from the spatial light modulator, wherein the first spatial light modulator pixel forms a second image pixel on the target at a position offset from the position of the first image pixel; and
wherein a difference in position between the first image pixel and the second image pixel is less than \sqrt{2}/2 of the first distance.

36. The method of claim 35, wherein the difference in position between the first image pixel and the second image pixel is less equal to or less than \sqrt{2}/3 of the pitch on the screen.

37. The method of claim 35, wherein the difference in position between the first image pixel and the second image pixel is less equal to or less than \sqrt{2}/4 of the pitch on the screen.

38. The method of claim 35, wherein the difference in position between the first image pixel and the second image pixel is less than \sqrt{2}/2 of a diagonal of the image pixel.

39. The method of claim 35, wherein the difference in position between the first image pixel and the second image pixel is less than \sqrt{2}/3 of a diagonal of the image pixel.

40. The method of claim 35, wherein the difference is along a diagonal of the image pixels.

41. The method of claim 35, wherein the difference is along a row or a column of the image pixel array.

42. The method of claim 41, wherein the difference is less than 1/2 of the width or column of an image pixel along a row or column of the image pixel array.

43. The method of claim 41, wherein the difference is less than ⅓ of the width or column of an image pixel along a row or column of the image pixel array.

44. The method of claim 43, wherein the difference is less than ¼ of the width or column of an image pixel along a row or column of the image pixel array.

45. The method of claim 35, wherein the difference is greater than a gap between adjacent image pixels, but less than ½ the pitch.

46. The method of claim 35, wherein the difference is greater than 1.5 times of the gap but less than 3 times the gap.

47. The method of claim 35, further comprising:
projecting the modulate light on a third array of image pixels on the screen other than the first and second arrays of image pixels.

48. The method of claim 47, further comprising:
projecting the modulate light on a forth array of image pixels on the screen other than the first, second, and third arrays of image pixels.

49. The method of claim 48, further comprising:
projecting the modulate light on a fifth array of image pixels on the screen other than the first, second, third, and forth arrays of image pixels.

50. The method of claim 35, wherein the light directed to the spatial light modulator is from an arc lamp.

51. The method of claim 35, wherein the light directed to the spatial light modulator is from a light source comprising a LED.

52. The method of claim 35, further comprising:
splitting the light into a set of different colors;
modulating the different colors separately by a spatial light modulator into different modulated colors; and
combining the different modulated colors into the modulated light.

53. The method of claim 52, wherein the different colors are modulated by different spatial light modulators.

54. The method of claim 52, wherein the different colors are modulated by at least two different spatial light modulators.

55. The method of claim 54, wherein the projecting of the modulated light onto the first and second arrays of image pixels are accomplished by a light module that is capable of directing the light onto different locations on the screen; and wherein the light module is disposed at a location when the different modulated colors are combined into the modulated light.

56. A projector, comprising:
first means for directing light onto a spatial light modulator comprising an array of device pixels resulting in modulated light;
second means for projecting the modulated light to a first array of image pixels on a screen with a pitch that is defined as a center-to-center distance between the adjacent image pixels;
third means for projecting the modulated light to a second image pixel array on the screen; and
wherein the image pixels of the first and second image pixel arrays on which the modulated light are projected from the same device pixel have an offset less than \sqrt{2}/2 of the pitch on the screen.

57-83. (canceled)
